(19) United States
(12) Patent Application Publication
(10) Pub. No.: US 2011/0155532 A1
(43) Pub. Date: Jun. 30, 2011

(54) CLUTCH DEVICE

(75) Inventors: Kingo Kuritani, Miyagi (JP); Yousuke Yamagami, Aichi (JP); Yuuichirou Okuda, Aichi (JP); Motohiko Ueda, Aichi (JP)

(73) Assignees: SHOEI ENGINEERING CO., LTD., Osaka-shi ,Miyagi (JP); DENSO CORPORATION, Aichi (JP)

(21) Appl. No.: 13/060,815

(22) PCT Filed: Feb. 24, 2010
(86) PCT No.: PCT/JP2010/052872

§ 371 Date: Feb. 25, 2011

(30) Foreign Application Priority Data
Apr. 10, 2009 (JP) 2009-096341

(51) Int. Cl. F16D 27/01; F16D 11/16

(52) U.S. Cl. 192/71

(57) ABSTRACT

To reduce running cost while preventing production of noise.

Provided are a pair of magnetic meshing rings (151) including magnetic meshing teeth (151b) arranged side by side on both an inner circumferential surface and an outer circumferential surface of a middle yoke member (15); a magnet member (152) situated between the pair of the magnetic meshing rings (151) such that the magnetic meshing teeth on one of the magnetic meshing rings (151) and magnetic meshing teeth on the other one of the magnetic meshing rings (151) have opposite magnetic poles; and a pair of meshing tooth rows (25) including a plurality of meshing teeth (25a) arranged side by side on an outer circumferential surface of an inner yoke member (21) and on an inner circumferential surface of an outer yoke member (22) and facing the magnetic meshing rings (151), the meshing tooth rows (25) being disposed at portions where the meshing tooth rows (25) face the inner and outer circumferential surfaces of the middle yoke member (15). The pair of magnetic meshing rings (151) and the pair of meshing tooth rows (25) are situated to be movable relative to each other between a facing position where the pair of magnetic meshing teeth (151b) and the pair of meshing teeth (25a) are positioned to face each other to cause the magnet member (152) to create a magnetic circuit between the magnetic meshing teeth (151b) and the meshing teeth (25a) and a not-facing position where the magnetic meshing teeth (151b) and the meshing teeth (25a) are positioned not to face each other.

### FIELD

The present invention relates to a clutch device configured to be switchable between an engaged state where power is transmitted between two rotating members and a disengaged state where power transmission is disengaged.

### BACKGROUND

As clutch devices of this type, various electromagnetic clutch devices have conventionally been provided. More specifically, they are configured such that one rotating member and the other rotating member are brought into and out of contact by switching on and off passage of electric current through an electromagnetic coil so that power is transmitted between the two rotating members by friction generated therebetween when the rotating members are in contact with each other (see, for instance, Patent Literature 1).
Patent Literature 1: Japanese Laid-open Patent Publication No. 2009-36229

### SUMMARY

### Technical Problem

However, in the clutch device described above, it is necessary to continuously apply electric current to the electromagnetic coil to transmit power between the two rotating members, which is not necessarily desirable from viewpoint of running cost. Furthermore, switching on and off passage of electric current through the electromagnetic coil brings the one rotating member and the other rotating member into and out of contact, which can result in a noise problem.

In view of the above circumstances, the present invention aims at providing a clutch device capable of reducing running cost while preventing production of noise.

### Solution to Problem

In order to solve the problem, the present invention is a clutch device provided between a first rotating member and a second rotating member to engage and disengage transmission of power between the two rotating members, the first rotating member being situated to be rotatable about a first axis and including a first rotational displacement surface that is displaced when the first rotating member rotates about the first axis, the second rotating member being situated to be rotatable about a second axis and including a second rotational displacement surface that is displaced when the second rotating member rotates about the second axis, the second rotating member being arranged such that at least a portion of the second rotational displacement surface faces the first rotational displacement surface. The clutch device includes a pair of magnetic-meshing tooth rows, each magnetic-meshing tooth row of the pair including a plurality of magnetic meshing teeth arranged on the first rotational displacement surface along a circumferential direction; a permanent magnet situated between the pair of the magnetic-meshing tooth rows such that the magnetic meshing teeth on one of the magnetic-meshing tooth rows and the magnetic meshing teeth on the other one of the magnetic-meshing tooth rows have opposite magnetic poles; and a pair of meshing tooth rows, each meshing tooth row of the pair including a plurality of meshing teeth arranged on the second rotational displacement surface along a circumferential direction and facing corresponding one of the magnetic-meshing tooth rows at the portion facing the first rotational displacement surface. The pair of the magnetic-meshing tooth rows and the pair of the meshing tooth rows are situated to be movable relative to each other between a facing position where a pair of the magnetic meshing teeth and a pair of the meshing teeth are positioned to face each other to cause the permanent magnet to create a magnetic circuit between the magnetic meshing teeth and the meshing teeth and a not-facing position where the magnetic meshing teeth and the meshing teeth are positioned not to face each other.

In the clutch device according to the present invention, the first rotating member and the second rotating member are situated to be rotatable about a common axis with the first rotational displacement surface and the second rotational displacement surface facing each other all around the axis, and the pair of the magnetic-meshing tooth rows and the pair of the meshing tooth rows are arranged such that the magnetic-meshing tooth rows on the first rotating member are situated apart from each other in a direction of the axis and the meshing tooth rows on the second rotating members are situated apart from each other in the direction of the axis, and moved between the facing position and the not-facing position when the first rotating member and the second rotating member are moved relative to each other along the direction of the axis.

In the clutch device according to the present invention, the second rotating member includes a pair of self-holding projections individually including continuous, annular circumferential surfaces that face leading-end surfaces of the magnetic-meshing tooth rows when the second rotating member is positioned in the not-facing position relative to the first rotating member.

In the clutch device according to the present invention, an annular groove is defined all around a leading-end surface of the self-holding projection.

In the clutch device according to the present invention, the magnetic meshing teeth on one of the pair of the magnetic-meshing tooth rows and the magnetic meshing teeth on the other one of the pair are arranged to be out of phase in the circumferential direction, and the second rotating member includes a pair of self-holding projections individually including continuous, annular circumferential surfaces that face leading-end surfaces of the magnetic-meshing tooth rows when the second rotating member is positioned in the not-facing position relative to the first rotating member.

The clutch device according to the present invention further includes a magnetic plate, on which different magnet poles are arranged along a circumferential direction, that is annular about the rotation axis and situated on one of a portion of the first rotating member where the first rotating member faces the second rotating member and the portion of the second rotating member; and a conductive member that is annular about the rotation axis and situated on the other one of the first rotating member and the second rotating member to face the magnet plate. When the pair of the magnetic-meshing tooth rows and the pair of the meshing tooth rows are positioned in the facing position, the magnet plate and the conductive member are positioned close to each other whereas when the pair of the magnetic-meshing tooth rows and the pair of the meshing tooth rows are positioned in the not-facing position, the magnet plate and the conductive member are positioned away from each other.

### Advantageous Effects of Invention

According to an aspect of the present invention, when leading-end surfaces of magnetic meshing teeth provided on one of rotating members face leading-end surfaces of magnetic meshing teeth provided on the other one of the rotating members, magnetic meshing between the magnetic meshing teeth and the meshing teeth is established, allowing power to be transmitted therebetween. The magnetic meshing between the magnetic meshing teeth and the meshing teeth is established by magnetic force generated by a permanent magnet. Accordingly, an advantage in terms of running cost is obtained because electric power is not consumed to maintain a state where power is transmissible between the two rotating members. Furthermore, the magnetic meshing between the magnetic meshing teeth and the meshing teeth does not involve contact therebetween. Accordingly, there is no possibility of occurrence of noise problem even when the two rotating members are engaged and disengaged.

### BRIEF DESCRIPTION OF DRAWINGS

FIG. 1 is a perspective, cross-sectional view of a situation where a clutch device according to an embodiment of the present invention is in an engaged state.

FIG. 2 is a perspective, cross-sectional view of a situation where the clutch device illustrated in FIG. 1 is in a disengaged state.

FIG. 3 is a diagram schematically illustrating a permanent magnet and magnetic meshing rings including magnetic meshing teeth for use in the clutch device illustrated in FIG. 1.

FIG. 4 is an enlarged partial view of a layout of the magnetic meshing teeth and meshing teeth in the clutch device illustrated in FIG. 1.

FIG. 5 is a partial perspective view illustrating a situation where the magnetic meshing rings and the permanent magnet illustrated in FIG. 3 are connected together.

FIG. 6 is a diagram schematically illustrating a mounting plate and a magnet plate for use in the clutch device illustrated in FIG. 1.

FIG. 7 is a conceptual diagram schematically illustrating a facing position and a not-facing position of the clutch device illustrated in FIG. 1.

FIG. 8 is a conceptual diagram schematically illustrating a facing position and a not-facing position in a modification of the clutch device illustrated in FIG. 1.

FIG. 9 is a conceptual diagram schematically illustrating a facing position and a not-facing position in another modification of the clutch device illustrated in FIG. 1.

### REFERENCE SIGNS LIST

10 Shaft member
11 Yoke retainer
15 Middle yoke member
20 Pulley
21 Inner yoke member
22 Outer yoke member
23 Magnet plate
25 Meshing tooth row
25a Meshing teeth
26 Self-holding projection
26a Annular grooves
151 Magnetic meshing ring
151b Magnetic meshing teeth
152 Magnet member
153 Mounting plate

### DESCRIPTION OF EMBODIMENTS

Exemplary embodiments of a clutch device according to the present invention are described in detail below with reference to the accompanying drawings.

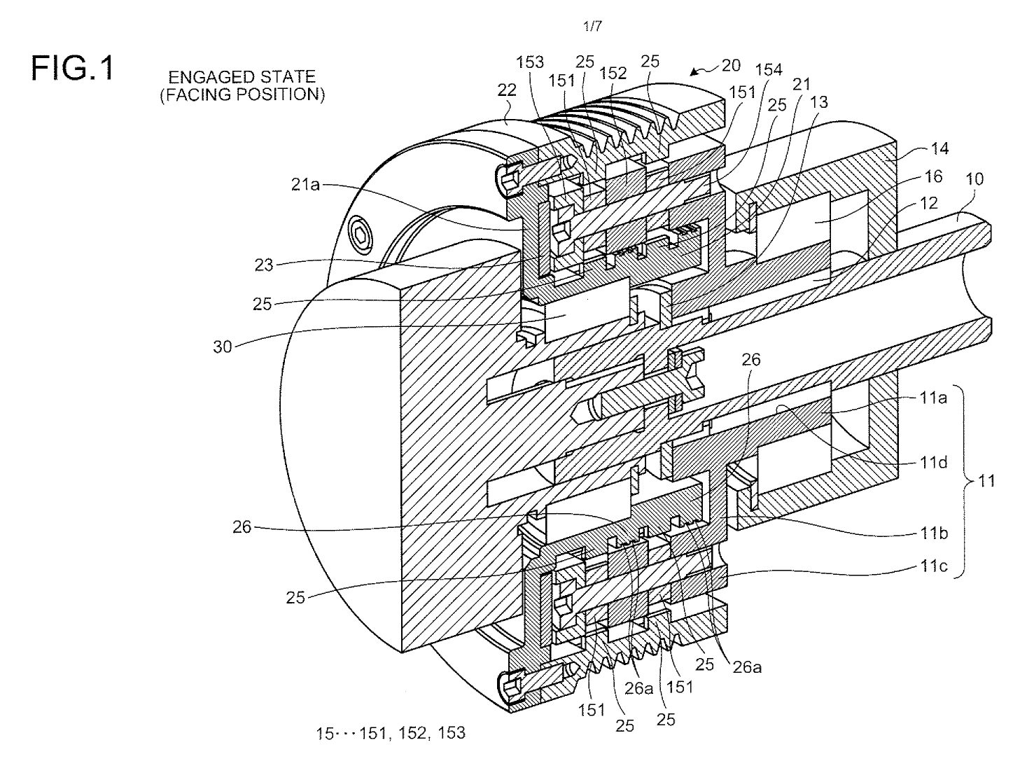

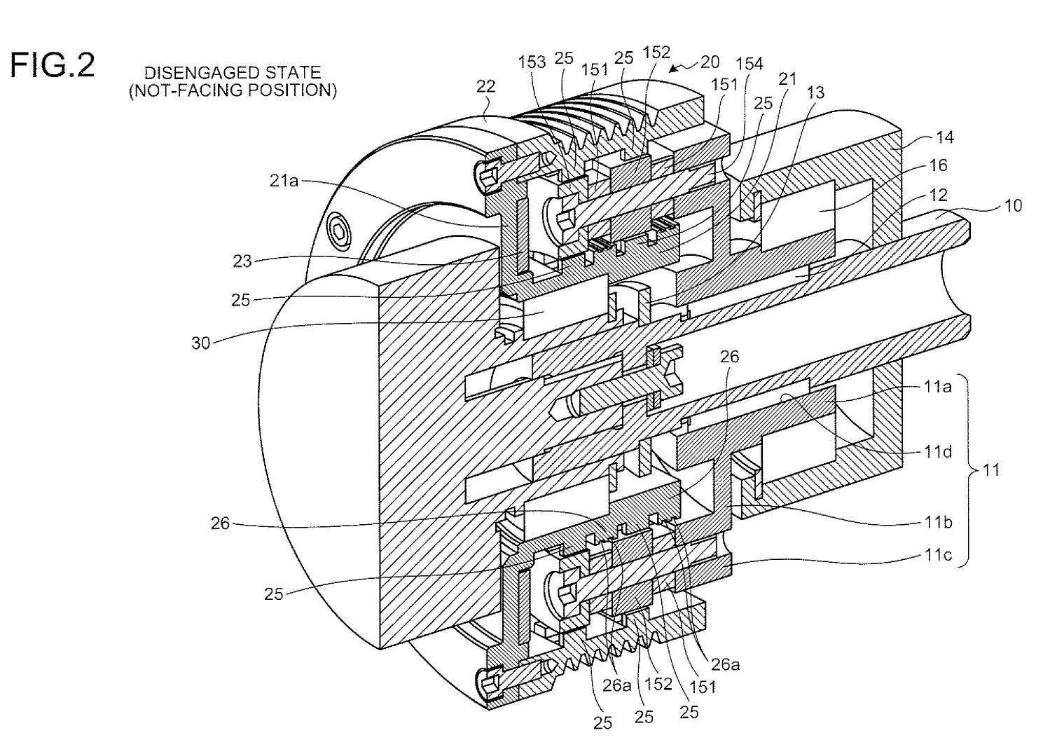

FIG. 1 and FIG. 2 illustrate a clutch device according to an embodiment of the present invention. The clutch device illustrated herein is provided between a leading-end portion of a shaft member (rotating member) 10 and a pulley (rotating member) 20 for engaging and disengaging power transmission between the shaft member 10 and the pulley 20. The pulley 20 supports the shaft member 10 through a pulley bearing 30 such that the pulley 20 is rotatable relative to the shaft member 10 at a portion radially outside of the shaft member 10 about an axis of the shaft member 10.

This clutch device includes a yoke retainer 11 radially outside of the shaft member 10. The yoke retainer 11 includes a cylindrical shaft casing portion 11a, a disk plate portion 11b that extends radially outward from an outer circumferential surface of the shaft casing portion 11a, and an annular mounting portion 11c that extends from an outer circumferential portion of the plate portion 11b along an axis of the shaft casing portion 11a. The yoke retainer 11 is situated on an outer circumferential portion of the shaft member 10 through the shaft casing portion 11a. A spline 11d is defined in an inner circumferential surface of the shaft casing portion 11a of the yoke retainer 11. The spline 11d meshes with a key member 12 provided on the shaft member 10 to allow the yoke retainer 11 to move along the axis of the shaft member 10 while restricting rotation of the yoke retainer 11 relative to the shaft member 10 along the axis. Meanwhile, reference numeral 13 in the drawing denotes a stopper plate that comes into contact with an end surface of the shaft casing portion 11a when the yoke retainer 11 is slid toward the leading end of the shaft member 10 to thereby restrict movement of the yoke retainer 11.

A sliding member 14 and a middle yoke member 15 are disposed on the yoke retainer 11. The sliding member 14 is a cylindrical member that is attached to an outer circumference of a basal end portion of the shaft casing portion 11a through an angular ball bearing 16 and situated radially outside of the shaft casing portion 11a and the shaft member 10 in a manner that the sliding member 14 is rotatable relative to both the shaft casing portion 11a and the shaft member 10.

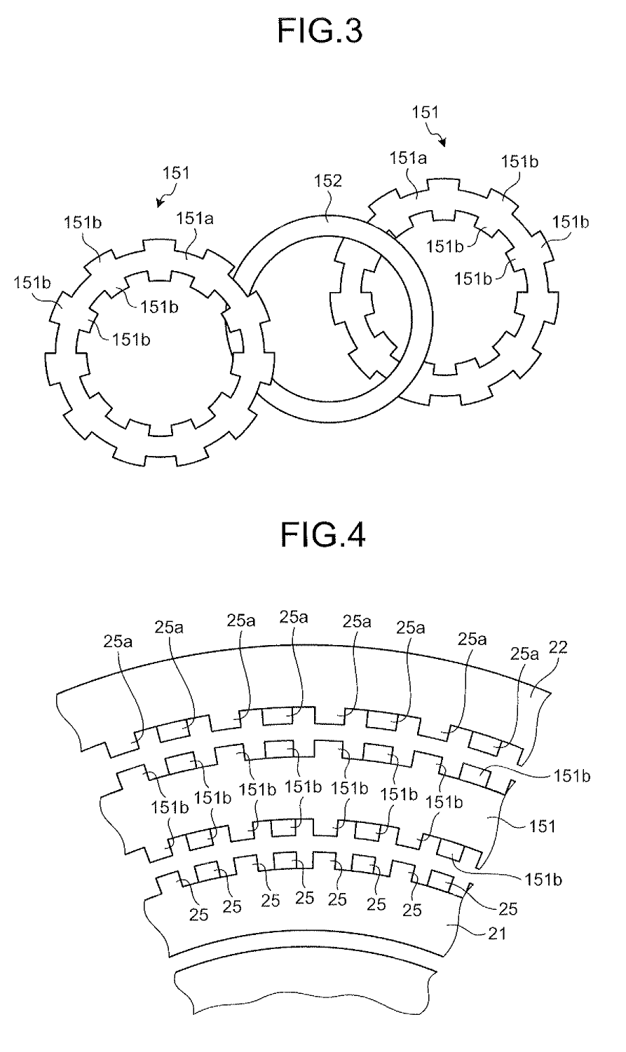

The middle yoke member 15 is a cylindrical member attached to the mounting portion 11c of the yoke retainer 11 and includes a pair of magnetic meshing rings (magnetic-meshing tooth rows) 151. As illustrated in FIG. 3, the magnetic meshing rings 151 of the pair are identically-shaped annulus members each including, on each of an outer circumferential surface and an inner circumferential surface of an annulus base portion 151a, a plurality of magnetic meshing teeth 151b and formed of a magnetic material, such as steel, for instance. As illustrated in FIG. 1 and FIG. 2, these magnetic meshing rings 151 are overlaid on the mounting portion 11c with a magnet member (permanent magnet member) 152 therebetween and fastened with a plurality of mounting bolts 154 through a mounting plate 153 to thus be attached on the mounting portion 11c of the yoke retainer 11 such that axes of the magnetic meshing rings 151 are aligned on a line.

As illustrated in FIG. 3 and FIG. 4, the magnetic meshing teeth 151b are projections that radially project from the outer circumferential surface and from the inner circumferential surface of the base portion 151a to form the magnetic-meshing tooth row on each of the inner circumferential surface (rotational displacement surface) and the outer circumferential surface (rotational displacement surface) of the middle yoke member 15. The magnetic meshing teeth 151b (hereinafter, referred to as “outer magnetic-meshing teeth” in some cases for distinction) provided on the outer circumferential surfaces of the magnetic meshing rings 151 are identical in dimensions and disposed at regular intervals along its circumferential direction. It is configured such that an outer diameter, which is defined by leading-end surfaces of the multiple outer magnetic-meshing teeth 151b, of the magnetic meshing rings 151 is substantially identical to that of the mounting portion 11c of the yoke retainer 11. The magnetic meshing teeth 151b (hereinafter, referred to as “inner magnetic-meshing teeth” in some cases for distinction) provided on the inner circumferential surface of the magnetic meshing ring 151 are identical in dimensions and disposed at regular intervals along circumferential direction. It is configured such that an inner diameter, which is defined by leading-end surfaces of the multiple inner magnetic-meshing teeth 151b, of the magnetic meshing rings 151 is substantially identical to that of the mounting portion 11c of the yoke retainer 11.

As illustrated in FIG. 3 and FIG. 5, the magnet member 152 is an annulus permanent magnet whose inner diameter and outer diameter are substantially identical to those of the base portions 151a of the magnetic meshing rings 151. The magnet member 152 is configured so as to have the north pole at one end surface and the south pole at the other end surface. In the present embodiment, as illustrated in FIG. 4 and FIG. 5, the pair of magnetic meshing rings 151 are arranged on the opposite end surfaces of the magnet member 152 such that the magnetic meshing teeth 151b at the one end surface of the magnet member 152 and the magnetic meshing teeth 151b at the other end surface of the magnet member 152 are out of phase in the circumferential direction. More particularly, the magnetic meshing teeth 151b are mounted on the mounting portion 11c of the yoke retainer 11 out of phase in the circumferential direction such that each of the magnetic meshing teeth 151b disposed on one of the magnetic meshing rings 151 is situated between adjacent magnetic meshing teeth of the magnetic meshing teeth 151b disposed on the other one of the magnetic meshing rings 151.

The mounting plate 153 has an annular shape whose inner diameter and outer diameter are substantially identical to those of the magnet member 152 and is formed of a conductive material, such as aluminum, for instance.

Meanwhile, the pulley 20 is configured to include an inner yoke member 21 and an outer yoke member 22. The inner yoke member 21 is a portion supported on the shaft member 10 through the pulley bearing 30 described above. The inner yoke member 21 is configured to have an outer diameter that is slightly smaller than an inner diameter of the middle yoke member 15 of the yoke retainer 11 and arranged such that an outer circumferential surface of the inner yoke member 21 faces an inner circumferential surface of the middle yoke member 15.

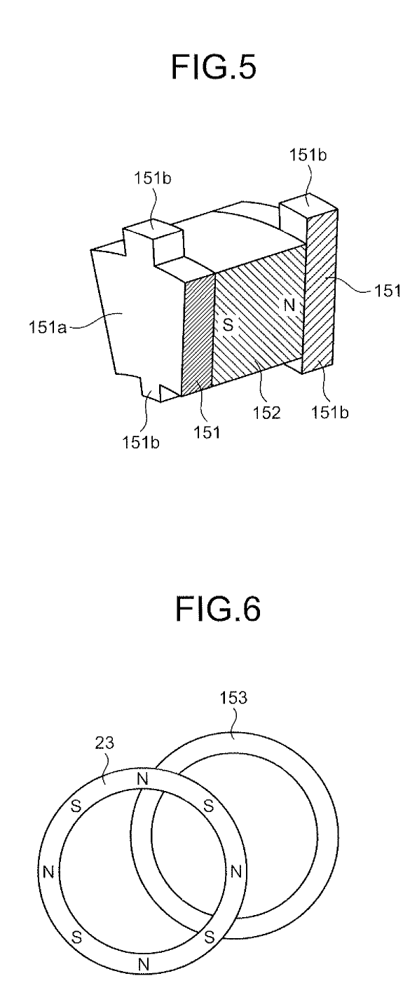

A disk portion 21a is provided on the inner yoke member 21 integrally therewith. The disk portion 21a is a flange portion that extends radially outward from an end portion of the inner yoke member 21 near the mounting plate 153 of the yoke retainer 11 and configured to have an outer diameter that is sufficiently larger than that of the magnetic meshing rings 151 mounted on the yoke retainer 11. A magnet plate 23 is disposed on the disk portion 21a at a portion facing an end surface of the mounting plate 153. As illustrated in FIG. 6, the magnet plate 23 is an annulus member whose outer diameter and inner diameter are substantially identical to those of the mounting plate 153. This magnet plate 23 is magnetized such that the north poles and the south poles are alternately arranged along the circumferential direction.

As illustrated in FIG. 1 and FIG. 2, the disk portion 21a of the inner yoke member 21 is configured such that even when the yoke retainer 11 is slid relative to the shaft member 10 to bring the end surface of the shaft casing portion 11a into contact with the stopper plate 13 (hereinafter, this layout related to the yoke retainer 11 is referred to “ON position”), put another way, even when the mounting plate 153 of the middle yoke member 15 is positioned to be nearest to the magnet plate 23, clearance is constantly provided between the end surface of the magnet plate 23 and the end surface of the mounting plate 153.

The outer yoke member 22 is a cylindrical member whose inner diameter is slightly larger than an outer diameter of the middle yoke member 15. This outer yoke member 22 is retained on an end surface of the disk portion 21a with an inner circumferential surface of the outer yoke member 22 facing the outer circumferential surface of the middle yoke member 15.

A pair of meshing tooth rows 25 is disposed such that one of the meshing tooth rows 25 is disposed on the outer circumferential surface (rotational displacement surface) of the inner yoke member 21 and the other one is disposed on the inner circumferential surface (rotational displacement surface) of the outer yoke member 22. The meshing tooth rows 25 include a plurality of meshing teeth 25a projecting radially outward and arranged along the circumferential direction. The meshing tooth rows 25 are disposed at positions away from each other by a same distance as a distance between the pair of magnetic meshing rings 151 disposed on the middle yoke member 15.

As illustrated in FIG. 4, the meshing teeth 25a (hereinafter, referred to as “outer meshing teeth” in some cases for distinction) provided on the outer circumferential surface of the inner yoke member 21 are configured to have dimensions and tooth pitch that are substantially identical to those of the inner magnetic-meshing teeth 151b provided on the inner circumferential surfaces of the magnetic meshing rings 151. The outer meshing teeth 25a on one of the meshing tooth rows 25 and the outer meshing teeth 25a on the other one of the meshing tooth rows 25 are out of phase in the circumferential direction. More specifically, the outer meshing teeth 25a and the outer meshing teeth 25a are arranged out of phase in the circumferential direction such that, when the outer meshing teeth 25a on the one of the meshing tooth rows 25 face the inner magnetic-meshing teeth 151b on one of the magnetic meshing rings 151, the outer meshing teeth 25a on the other one of the meshing tooth rows 25 face the inner magnetic-meshing teeth 151b on the other one of the magnetic meshing rings 151.

The meshing teeth 25a (hereinafter, referred to as “inner meshing teeth” in some cases for distinction) provided on the inner circumferential surface of the inner yoke member 21 are configured to have dimensions and tooth pitch that are substantially identical to those of the outer magnetic-meshing teeth 151b provided on the outer circumferential surfaces of the magnetic meshing rings 151. The inner meshing teeth 25a on one of the meshing tooth rows 25 and the inner meshing teeth 25a on the other one of the meshing tooth rows 25 are out of phase in the circumferential direction. More specifically, the inner meshing teeth 25a and the inner meshing teeth 25a are arranged out of phase in the circumferential direction such that, when the inner meshing teeth 25a on the one of the meshing tooth rows 25 face the outer magnetic-meshing teeth 151b on one of the magnetic meshing rings 151, the inner meshing teeth 25a on the other one of the meshing tooth rows 25 face the outer magnetic-meshing teeth 151b on the other one of the magnetic meshing rings 151.

As is apparent from FIG. 1 and FIG. 2, the meshing tooth rows 25 provided on the pulley 20 are configured such that, with the yoke retainer 11 positioned in the ON position, the meshing tooth, rows 25 face each of the pair of the magnetic meshing rings 151 provided on the middle yoke member 15 whereas when the yoke retainer 11 is slid along the axis of the shaft member 10 to bring the end surface of the shaft casing portion 11a away from the stopper plate 13, the meshing tooth rows 25 face none of the of magnetic meshing rings 151 (hereinafter, this layout related to the yoke retainer 11 is referred to “OFF position”).

A pair of self-holding projection 26 is disposed on the inner yoke member 21. Each of the self-holding projections 26 is an annular projection that projects radially outward from the outer circumferential surface of the inner yoke member 21 and configured to have constant height all around itself. The height of the self-holding projection 26 at its tip portion is identical with the height of the meshing teeth 25a at their tip portions. These self-holding projections 26 are situated at positions where the self-holding projections 26 face the magnetic meshing teeth 151b on the magnetic meshing rings 151 when the yoke retainer 11 is positioned in the OFF position.

Two annular grooves 26a are defined in each of the self-holding projections 26. The annular grooves 26a are defined all around a leading-end surface of the self-holding projection 26 to section a leading-end portion of the self-holding projection 26 into three.

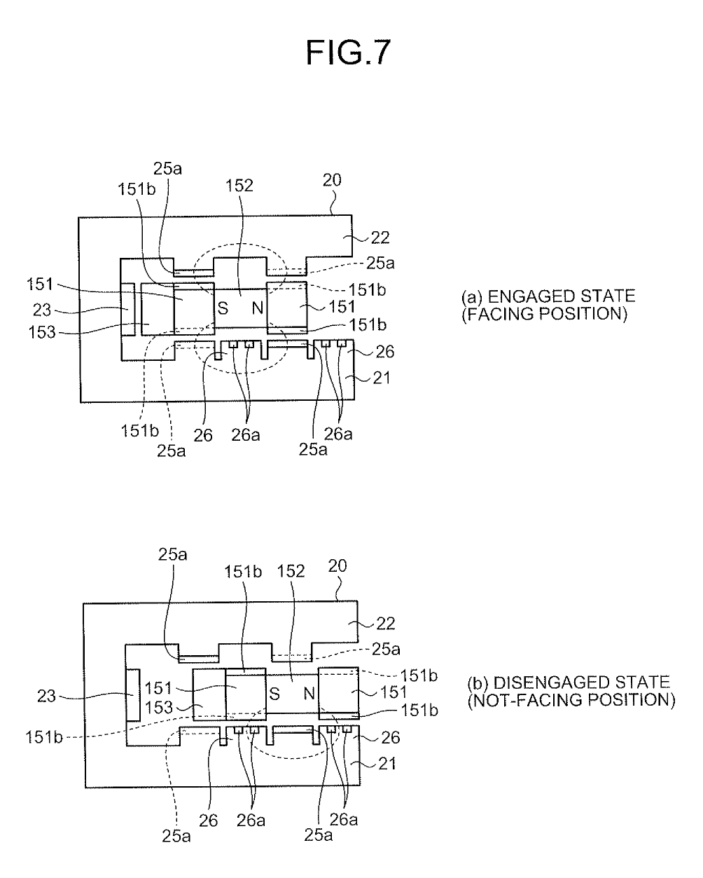

In the clutch device configured as described above, when the yoke retainer 11 is positioned in the ON position as illustrated in (a) of FIG. 7, the magnetic meshing rings 151 provided on the middle yoke member 15 face the meshing tooth rows 25 on the inner yoke member 21 and the meshing tooth rows 25 on the outer yoke member 22 (facing position). When, in this state, the magnetic meshing teeth 151b on the magnetic meshing rings 151 and the meshing teeth 25a on the meshing tooth rows 25 are brought into a state where the leading-end surfaces of the magnetic meshing teeth 151b and those of the meshing teeth 25a face each other, as illustrated in the drawing, the magnet member 152 situated between the magnetic meshing teeth 151b creates a magnetic circuit between the middle yoke member 15, and the outer yoke member 22 and the inner yoke member 21. In this situation, torques are developed between the middle yoke member 15, and the outer yoke member 22 and the inner yoke member 21 because the magnetic meshing teeth 151b are provided on the magnetic meshing rings 151 and because the meshing teeth 25a are provided on the meshing tooth rows 25. Furthermore, the magnet plate 23 provided on the disk portion 21a and the mounting plate 153 are positioned to be close to each other, inducing, when there is difference in the number of rotation of the magnet plate 23 and that of the mounting plate 153, eddy current through the mounting plate 153, thereby causing an auxiliary torque that acts for synchronous rotation of the magnet plate 23 and the mounting plate 153.

Hence, for instance, rotating a timing belt wound around the outer yoke member 22 about the axis causes the middle yoke member 15 to rotate about the axis as well, causing the shaft member 10 coupled to the yoke retainer 11 through the spline 11d to rotate about the axis (engaged state).

In the clutch device described above, the engaged state is maintained by the magnet circuit created by the magnet member 152. Accordingly, a considerably great advantage in terms of running cost is obtained because, unlike a conventional electromagnetic clutch device, electric power is not consumed to maintain the engaged state.

In contrast, when the yoke retainer 11 is slid relative to the shaft member 10 through the sliding member 14 to position the yoke retainer 11 in the OFF position as illustrated in (b) of FIG. 7, the magnetic meshing rings 151 provided on the middle yoke member 15 do not face the meshing tooth rows 25 on the inner yoke member 21 and the meshing tooth rows 25 on the outer yoke member 22 while the magnetic meshing rings 151 and the self-holding projections 26 face each other, causing the magnet member 152 to create a magnetic circuit between the middle yoke member 15 and the inner yoke member 21 as illustrated in the drawing (not-facing position). However, a torque is not produced between the middle yoke member 15 and the inner yoke member 21 because, as described above, the self-holding projections 26 are configured to have a constant height at its tip portion and therefore do not have a meshing tooth. In addition, even when there is relative movement between the magnet plate 23 provided on the disk portion 21a and the mounting plate 153, little eddy current is induced because the magnet plate 23 and the mounting plate 153 are positioned to be away from each other. Hence, even when the outer yoke member 22 is rotated about the axis, neither the middle yoke member 15 nor the shaft member 10 is rotated, bringing about a state where power transmission between the middle yoke member 15 and the shaft member 10 is disengaged.

In this disengaged state, the middle yoke member 15 is stabled in terms of position relative to the shaft member 10 because, as described above, the magnetic meshing rings 151 are configured to oppose the self-holding projections 26 in the not-facing position. Furthermore, the magnetic meshing teeth 151b on one of the magnetic meshing rings 151 and the magnetic meshing teeth 151b on the other one of the magnetic meshing rings 151 are out of phase in the circumferential direction. This acts to cancel a very small residual transmission torque (drag torque) between the meshing teeth 25a and the inner yoke member 21 that are positioned between the magnetic meshing teeth 151b, thereby achieving reduction of the drag torque. Furthermore, the annular grooves 26a defined in the self-holding projections 26 also act to prevent induction of the eddy current, thereby further reducing the drag torque that can be produced by relative rotation between the middle yoke member 15 and the inner yoke member 21.

As described above, in the clutch device described above, when the magnetic meshing teeth 151b and the meshing teeth 25a come to face each other, magnetic meshing between magnetic meshing teeth 151b and the meshing teeth 25a occurs, allowing power transmission therebetween. The magnetic meshing between the magnetic meshing teeth 151b and the meshing teeth 25a is established by magnetic force generated by the magnet member 152. Accordingly, an advantage in terms of running cost is obtained because electric power is not consumed to maintain the state where power is transmissible between the pulley 20 and the shaft member 10. Furthermore, the magnetic meshing between the magnetic meshing teeth 151b and the meshing teeth 25a does not involve contact therebetween. Accordingly, there is no possibility of occurrence of noise problem even when power transmission is engaged and disengaged.

The embodiment has been described by way of an example where the clutch device connects and disconnects power transmission between the shaft member 10 and the pulley 20; however, examples of the rotating members are not necessarily limited to the shaft member 10 and the pulley 20 and can include other elements so long as the elements rotate about an axis. Meanwhile, rotating about a common axis is not necessarily a prerequisite for the two rotating members; application to two rotating members that rotate about different axes is also possible. The embodiment has been described by way of the example where the pulley 20 corresponds to a driving side and the shaft member 10 corresponds to a driven side in engaging and disengaging power transmission between the shaft member 10 and the pulley 20; however, as a matter of course, another configuration where their roles are reversed can be employed.

In the embodiment described above, the magnetic meshing teeth 151b and the meshing teeth 25a are provided between the middle yoke member 15 and the outer yoke member 22 and between the middle yoke member 15 and the inner yoke member 21; however, another configuration where any one of the outer yoke member 22 and the inner yoke member 21 faces the middle yoke member 15 can be employed.

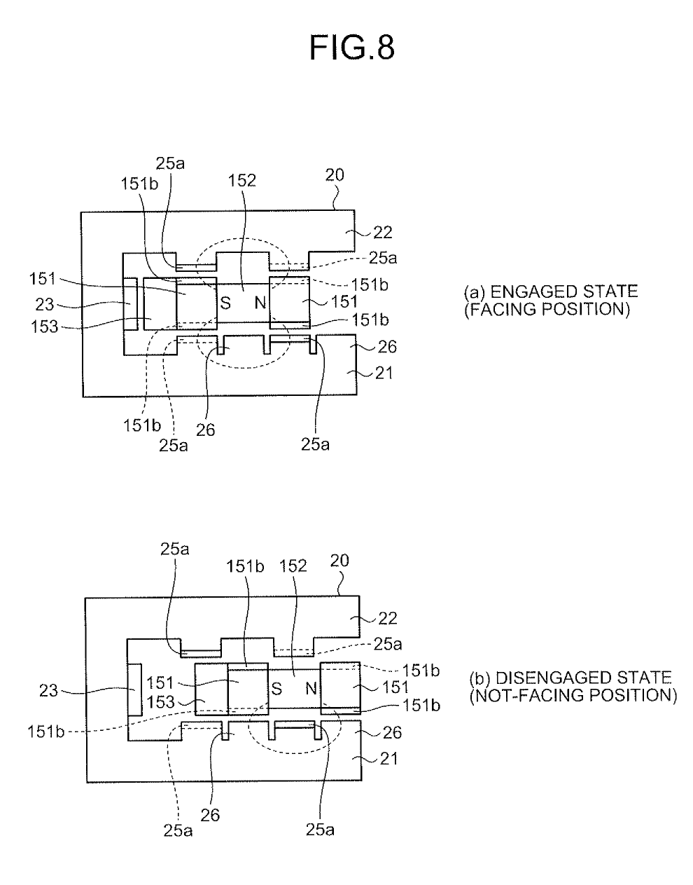

In the embodiment described above, the magnetic meshing teeth 151b on the pair of magnetic-meshing tooth rows (151) are arranged out of phase in the circumferential direction, and the annular grooves 26a are defined in the self-holding projections 26; however, providing both of these is not necessarily required. For instance, as in a modification illustrated in FIG. 8, where the magnetic meshing teeth 151b on the pair of magnetic-meshing tooth rows (151) are arranged out of phase in the circumferential direction, the annular grooves 26a in the self-holding projections 26 can be omitted. In contrast, in a configuration where the annular grooves 26a are defined in the self-holding projections 26, the magnetic meshing teeth 151b on the pair of magnetic-meshing tooth rows (151) can be positioned to face each other.

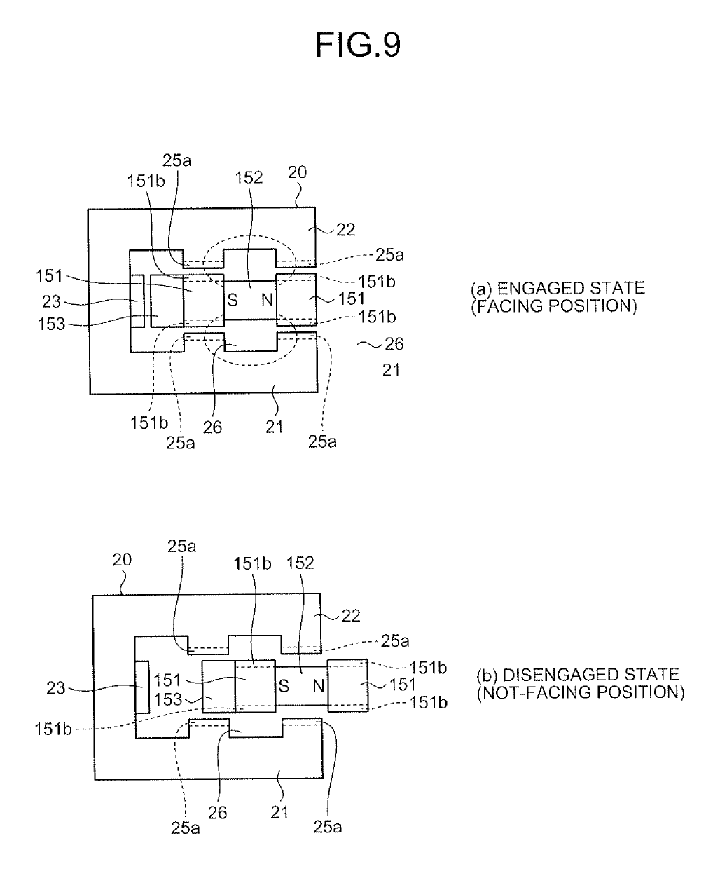

In the embodiment described above, the middle yoke member 15 is stabled in terms of position relative to the shaft member 10 in the not-facing position because the self-holding projections 26 are provided; however, further alternatively, the self-holding projections 26 can be omitted as illustrated in FIG. 9.

In the embodiment described above, the clutch device is situated between the circumferential surface of one of the rotating members and the circumferential surface of the other one of the rotating members; however, the clutch device is not necessarily situated between the circumferential surfaces. For instance, it is possible to configure a clutch device between flanges, of which surfaces that face each other serve as the rotational displacement surfaces, that are individually formed on the one rotating member and the other rotating member. In this case, each of the pair of magnetic-meshing tooth rows (151) and the pair of the meshing teeth is cocentrincally arranged. Moving these tooth rows relative to each other in the radial direction causes switching between a facing position and a not-facing position to occur.

In the embodiment described above, eddy current induced between the mounting plate 153 and the magnet plate 23 is also utilized; however, the magnet plate 23 is not necessarily required.

1. A clutch device provided between a first rotating member and a second rotating member to engage and disengage transmission of power between the two rotating members, the first rotating member being situated to be rotatable about a first axis and including a first rotational displacement surface that is displaced when the first rotating member rotates about the first axis, the second rotating member being situated to be rotatable about a second axis and including a second rotational displacement surface that is displaced when the second rotating member rotates about the second axis, the second rotating member being arranged such that at least a portion of the second rotational displacement surface faces the first rotational displacement surface, the clutch device comprising:
a pair of magnetic-meshing tooth rows, each magnetic-meshing tooth row of the pair including a plurality of magnetic meshing teeth arranged on the first rotational displacement surface along a circumferential direction;
a permanent magnet situated between the pair of the magnetic-meshing tooth rows such that the magnetic meshing teeth on one of the magnetic-meshing tooth rows and the magnetic meshing teeth on the other one of the magnetic-meshing tooth rows have opposite magnetic poles; and
a pair of meshing tooth rows, each meshing tooth row of the pair including a plurality of meshing teeth arranged on the second rotational displacement surface along a circumferential direction and facing corresponding one of the magnetic-meshing tooth rows at the portion facing the first rotational displacement surface, wherein
the pair of the magnetic-meshing tooth rows and the pair of the meshing tooth rows are situated to be movable relative to each other between a facing position where a pair of the magnetic meshing teeth and a pair of the meshing teeth are positioned to face each other to cause the permanent magnet to create a magnetic circuit between the magnetic meshing teeth and the meshing teeth and a not-facing position where the magnetic meshing teeth and the meshing teeth are positioned not to face each other.

2. The clutch device according to claim 1, wherein
the first rotating member and the second rotating member are situated to be rotatable about a common axis with the first rotational displacement surface and the second rotational displacement surface facing each other all around the axis, and
the pair of the magnetic-meshing tooth rows and the pair of the meshing tooth rows are arranged such that the magnetic-meshing tooth rows on the first rotating member are situated apart from each other in a direction of the axis and the meshing tooth rows on the second rotating members are situated apart from each other in the direction of the axis, and moved between the facing position and the not-facing position when the first rotating member and the second rotating member are moved relative to each other along the direction of the axis.

3. The clutch device according to claim 2, wherein the second rotating member includes a pair of self-holding projections individually including continuous, annular circumferential surfaces that face leading-end surfaces of the magnetic-meshing tooth rows when the second rotating member is positioned in the not-facing position relative to the first rotating member.

4. The clutch device according to claim 3, wherein an annular groove is defined all around a leading-end surface of the self-holding projection.

5. The clutch device according to claim 2, wherein
the magnetic meshing teeth on one of the pair of the magnetic-meshing tooth rows and the magnetic meshing teeth on the other one of the pair are arranged to be out of phase in the circumferential direction, and
the second rotating member includes a pair of self-holding projections individually including continuous, annular circumferential surfaces that face leading-end surfaces of the magnetic-meshing tooth rows when the second rotating member is positioned in the not-facing position relative to the first rotating member.

6. The clutch device according to claim 2, further comprising:
a magnetic plate, on which different magnet poles are arranged along a circumferential direction, that is annular about the rotation axis and situated on one of a portion of the first rotating member where the first rotating member faces the second rotating member and the portion of the second rotating member; and
a conductive member that is annular about the rotation axis and situated on the other one of the first rotating member and the second rotating member to face the magnet plate, wherein
when the pair of the magnetic-meshing tooth rows and the pair of the meshing tooth rows are positioned in the facing position, the magnet plate and the conductive member are positioned close to each other whereas when the pair of the magnetic-meshing tooth rows and the pair of the meshing tooth rows are positioned in the not-facing position, the magnet plate and the conductive member are positioned away from each other.
